(19) United States
(12) Patent Application Publication
(10) Pub. No.: US 2008/0280251 A1
(43) Pub. Date: Nov. 13, 2008

(54) Dent-Chew Brush

(76) Inventor: John Henry Gallagher, Haverford, PA (US)

Correspondence Address: John H. Gallagher, Jr., 10 Williams Road, Haverford, PA, 19041, US

(21) Appl. No.: 11/701,856

(22) Filed: Feb. 1, 2007

Related U.S. Application Data
(60) Provisional application No. 60/764,119, filed on Feb. 1, 2006.

(51) Int. Cl. A61C 17/00

(52) U.S. Cl. 433/80

(57) ABSTRACT

The Dent-Chew Brush is an oral appliance designed similarly to a mouth guard, in that it has two inverted channels in which the teeth are positioned when it is placed into the mouth. In its completed design it provides the user with the ability to brush all three exposed surfaces of the teeth of the upper and lower bite, the gingival margin, and the surface of the tongue. The completed process produces clean teeth and freshened breath that is comparable to a traditional brushing. The appliance will provide military personnel in the field the same level of oral hygiene as traditional brushing but without the need for water or a dentifrice. Additionally, the market includes anyone who desires to brush their teeth at their discretion using a completely self contained appliance. The Dent-Chew Brush is a single use disposable piece that is water soluble and bio-degradable.

### CROSS-REFERENCE TO RELATED APPLICATIONS

I hereby claim all priority rights and prior art contained in application Ser. No. 07/095,135 filed Sep. 11, 1987 and subsequently abandoned. I additionally claim all priority rights and prior art contained in the Provisional application No. 60/764,119 filed Feb. 2, 2006.

### FEDERALLY SPONSORED RESEARCH OR DEVELOPMENT

Not Applicable

### REFERENCE TO SEQUENCE LISTING

Not Applicable

### BACKGROUND OF THE INVENTION

The Dent-Chew Brush relates to an oral appliance that provides the anticipated results of traditional brushing e.g. clean teeth and tongue, freshened breath and removal of plaque at the gingival margin. Its distinction is that it is specifically designed as a single use disposable piece. The appliance is ideal for anyone who is traveling or for whatever reason is unable to access potable water and a dentifrice to enable the use of a traditional brush.

Initially the utility being sought was to benefit military personnel in the field where hygiene is often inaccessible due in part to perils or a theaters' hostile climate and the need to conserve water. The list has been expanded however to users who have short terms needs such as airline passengers and people who would like to brush at mid-day with discretion. Also included are victims of natural disaster or relief recipients in third world countries, as well as people who through injury or other causes have reduced dexterity.

It is realized that many individual users may simply desire fresh breath or a cleaner feeling mouth but the appliances ability to provide effective plaque removal for those using it on a consistent basis is notable. All of this is accomplished by merely chewing a handleless mouth piece like appliance just as you would chew anything else in a straight up and down motion. In this way the optimum result is predictable regardless of the user while the vertical brushing path is strictly maintained. Although comparable to the results of the traditional brush it is not seen as a replacement to the brush but rather an alternative that has merit when brushing is impractical or inconvenient. The use of the appliance in no way reduces the need for regular flossing to prevent gum diseases such as gingivitis.

### BRIEF SUMMARY OF INVENTION

The Dent-Chew Brush is an oral appliance designed similarly to a mouth guard, in that it has two inverted channels in which the teeth are positioned when it is placed into the mouth. In its completed design it provides the user with the ability to brush all three exposed surfaces of the teeth of the upper and lower bite, the gingival margin, and the surface of the tongue. The completed process produces clean teeth and freshened breath that that is comparable to a traditional brushing. The appliance was created to provide military personnel in the field the same level of oral hygiene as traditional brushing but without the need for water or the carrying of a brush and a dentifrice. Additionally the market would include anyone who desires to brush their teeth at their discretion using a completely self contained appliance. The Dent-Chew Brush is a single use disposable piece that is water soluble and bio-degradable.

### BRIEF DESCRIPTION OF THE SEVERAL VIEWS OF THE DRAWINGS

FIG. 1 is a view of the rear elevation of the appliance as it would be seen by the user inserting into the mouth. Various illustrations of bristles, vacuum release ports are depicted sparingly but are in greater plurality.

FIG. 2 is a plan view of the appliance showing material ports throughout the maxillary arch and vacuum release ports positioned randomly throughout the palate brace.

FIG. 3 is a reflective plan view illustrating the mandibular arch revealing the lingual brace and the exposed portion of the palate brace.

FIG. 4 is a side elevation view of the appliance.

FIG. 5 is a front elevation view of the appliance.

FIG. 6 is a view of a cross-section of the appliance taken from the buccal portion of the maxillary and mandibular arches.

FIG. 7 is a view of the cross-section of the appliance taken from the facial portion of the maxillary and mandibular arches in areas other than that of the facial centerline where the inhalation port is located.

FIG. 8 is a vertical view depicting the angular protrusions of 45°, 90° and 135° from a vertical line perpendicular to the plane created by the teeth's cusps.

### DETAILED DESCRIPTION OF THE INVENTION

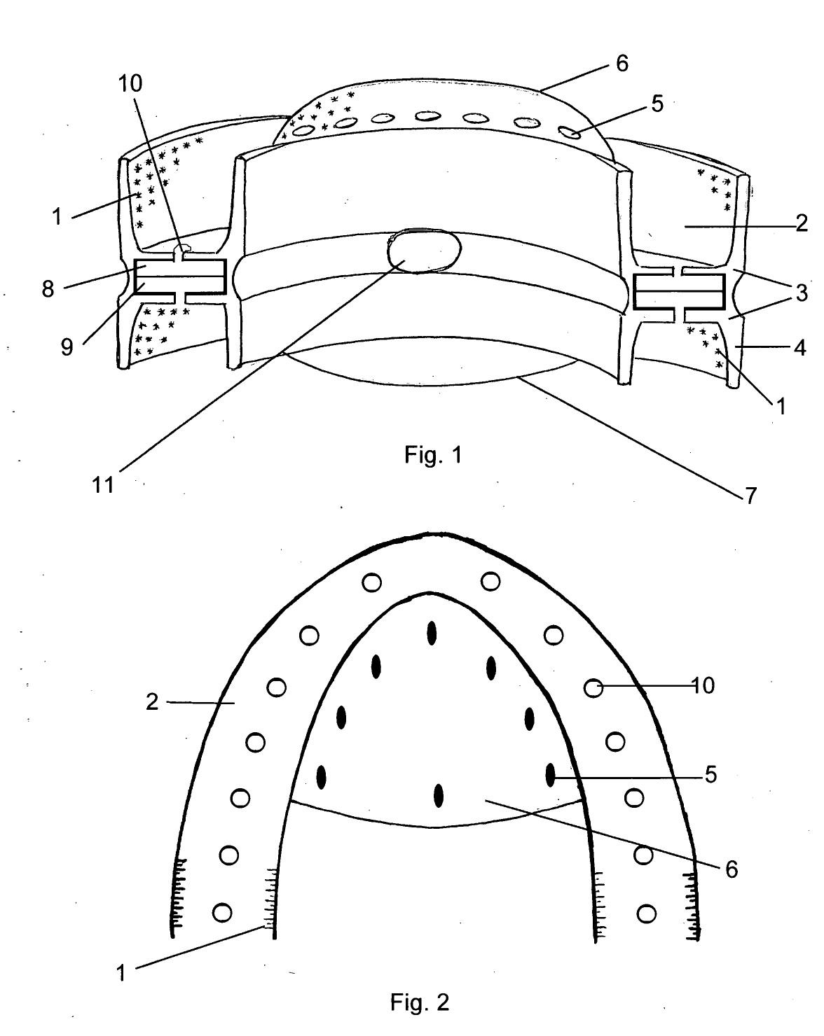

The invention is an oral appliance referring to FIG. 1 that is designed as a one time use disposable item. Its appearance is much like a mouth guard in a cursory view but with greater uniqueness. Like a mouth guard it has two arched channels that are fabricated in an inverted fashion to each other so that upper and lower channels can accept the teeth that are in the maxillary 2 and mandibular 4 arches respectively, and shall sometimes herein be referred to as the “upper bite channel” 2 and the “lower bite channel” 4 respectively in singular form and jointly as the “upper and lower bite channels.” When placed in the oral cavity correctly all vertical crown surfaces of all the teeth and their cusps are in full contact with the interior surfaces of the upper 2 and lower 4 bite channels of the oral appliance.

The upper and lower bite channels, although inverted to each other, are separated by and attached to, a dentifrice reservoir 3 that is also divided horizontally to create an upper dentifrice 8 and lower dentifrice 9 reservoirs of substantially equal size and volume. Located on the horizontal surfaces of both the upper and lower bite chambers that are common to the respective upper and lower dentifrice reservoirs are strategically placed apertures 10 that permit the passage of the dentifrice from the adjacent dentifrice reservoir into the bite chambers upon the reservoirs compression.

The interior surfaces of the bite channels are lined with a multitude of brushes 1 that vary in length, angle and thickness. The abundant number of brushes are set at varying angles such that they strike a tooth's vertical surface at 45°, 90° and 135° as depicted in FIG. 8, when measured from a perpendicular line off the horizontal plane of the tooth's cusp. Longer brushes that fall into the interproximal regions of the oral cavity will cleanse and remove hard to reach food particles while this same type of brush, when positioned directly on the surface of a tooth, will provide a broader sweeping action as a result of its deflection. Shorter brushes when occupying the interproximal regions will aid in agitating the dentifrice to enhance the dislodging of larger food particles and when positioned directly on the tooth's surface provides the desired brushing of both the tooth and the gingival margin to remove plaque. The thickness of the bristles will be approximately 10 to 17 mils at the connection of the interior channels of the upper and lower bite, as well as the interior surface of the palate brace 6. The length of these bristles may vary but in generality would have a length of 1/16^{th} to ⅛^{th} inch and a maximum taper at the extreme end of not less then three mils as seen in FIG. 8.

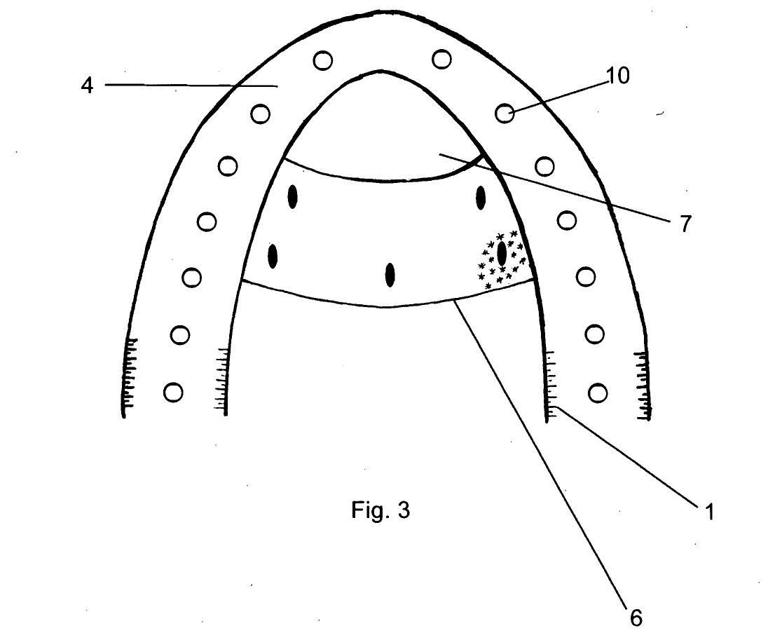

Spanning the roof of the mouth is the palate brace shown in FIG. 2 which is connected to the upper most edge of the interior wall of the upper bite channel. It is conforming and covers the roof of the mouth to what is approximately a lateral line that would connect the first molars opposite each other on the maxillary arch and it has two distinct functions. It is profiled with numerous brushes visible in FIG. 3 that are of multiple lengths and comprised of differing angles and thickness to provide a surface on which to scrub the tongues' papillae with varying degrees of abrasiveness. The palate brace 6 also stabilizes the oral appliance in order to thoroughly cleanse the teeth contained in the mandibular arch. By applying pressure against the roof of the mouth with the tongue the palate brace locks the oral appliance in place and by chewing the dentifrice reservoirs are compressed, injecting the dentifrice into the upper and lower bite channels. While continuing the tongues pressure on the roof of the mouth a slow chewing motion will brush and cleanse the lower bite. To prevent vacuum lock against the roof of the mouth vacuum ports 5 are strategically placed apertures on the palate brace as seen in FIGS. 1 and 2.

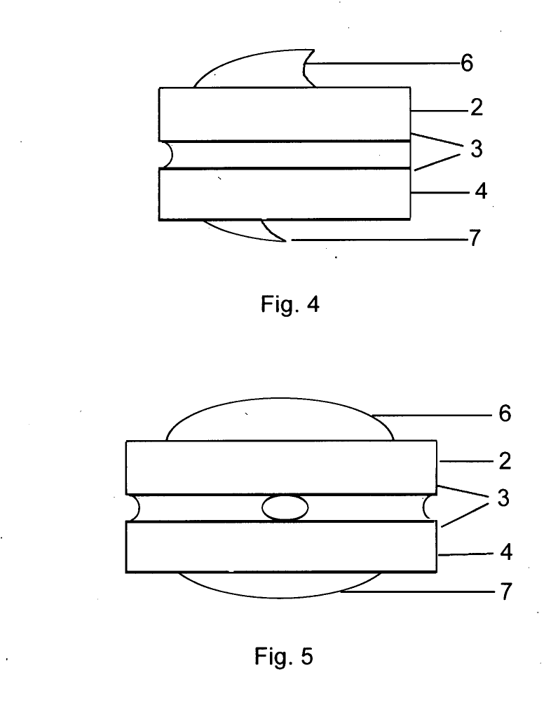

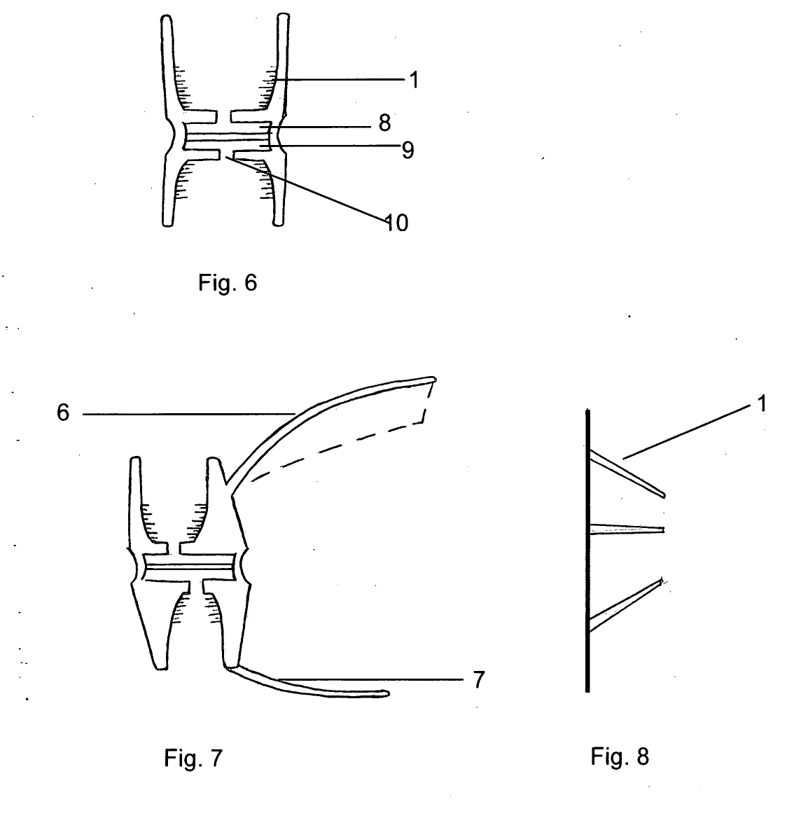

Similarly the lower bite channel 4 is spanned by the Lingual Brace from its corresponding lower edge on a lateral line that approximately intersects with the interproximal area between the 1^{st} and 2^{nd} premolar (bicuspid 21-20) and the 1^{st} and 2^{nd} premolar (bicuspid 28-29). When the upper bite is to be cleansed the tongue is depressed against the lingual brace 7 visible vertically in FIGS. 4 and 5, which holds the oral appliance in place against the lower bite. If this does not provide a locked positioning on the lower bite then slight pressure can be provided externally to the cheeks with the thumb and forefinger to help in positioning. Then a steady chew motion will clean the upper bite as the teeth and gingival margin of the maxillary arch move in and out of the upper bite channel until the desired result is achieved.

There is a breathing port 11 as seen in FIGS. 1 and 5 that provides an opening through the upper and lower dentifrice reservoir at the facial centerline of the maxillary and the lingual arches, should breathing through the nostrils not be possible.

To brush the cusps surfaces of both the upper and lower bites the tongue is not used to stabilize the appliance and only a slight pressure is applied in closing the bite while using a grinding motion side to side or front to back to clean.

The entire appliance is monolithic and manufactured of the same substance comprised primarily of a gelatin compound with high bloom strength in excess of 150 grams. The materials formulation enables the disposable unit to be both water soluble and biodegradable. Biodegradable characteristics may among other attributes be enticing for the consumption by insects. High tinsel strength and a low compressive strength affords an overall conformability enabling a small number of varying sizes to comfortably fit users whose maxillary, mandibular arches and varying occlusions will make up the using public.

What I claim as my invention is:

1. An oral appliance designed as a single use disposable unit that both brushes the exposed surfaces of the teeth, the gingival margin, the surface of the tongue and other parts of the oral cavity and freshens the breath.

2. The appliance is comprised of two inverted channels designed to accept the teeth which comprise the maxillary and mandibular arches of the oral cavity.

3. The inverted channels of claim 2 are separated by a reservoir designed to discharge a dentifrice equally throughout the maxillary and mandibular arches upon compression.

4. The reservoir of claim 3 is divided horizontally into two chambers that are substantially the same in size and volume enabling approximately the same volume of dentifrice to be discharged to the opposing arches upon initial compression.

5. The chambers of claim 4 have apertures randomly positioned throughout its common wall with its respective adjacent arch; these apertures are of sufficient dimension to enable the efficient delivery of dentifrice equally throughout its adjacent arch.

6. The division of the reservoir of claim 3 is a stable membrane connected to the exterior vertical walls of the inverted channels and their connection by way of the exterior wall of the reservoir and maintains segregation of the dentifrice found in the opposing chambers.

7. As of claim 2 the inverted channels have monolithic protrusions in the form of brushes of varying lengths enabling optimum cleaning of contacted enamel, cusps surfaces as well as gingival margins.

8. As of claim 7 the brushes are optimally fixed at 45°, 90° and 135° when measured off a vertical line perpendicular to the plane created by the teeth's cusps.

9. As of claim 7 the brushes varying lengths provide optimum cleansing when in direct contact with a tooth's surface and when occupying the inner proximal regions they enhance the removal of food particles.

10. As of claim 9 the brushes of varying lengths, while in combination occupy the inner proximal regions enhance the dentifrice's cleansing ability through agitation and aeration of the region.

11. As of claim 7 the brushes will have a variance of thicknesses at their base providing a predictable range of flexibility and distortion enabling greater degrees of mild abrasion, minimizing the need for dentifrice abrasive additives.

12. A connecting palate brace is attached to the palatal wall of the upper channel comprising the maxillary arch and such connection runs between the approximate positions of the two first molars position on the arch.

13. As of claim 12, the palatal brace is conforming and has monolithic protrusions as per claim 7.

14. As of claim 13, the brushes have exceptional utility in scrubbing the tongue with a minimal amount of surface abrasion as of claim 8.

15. A stabilization of the palatal brace exerted with the force of the tongue enables the teeth comprised in the mandibular arch to be cleaned as of claims 7 and 9 by merely chewing.

16. Due to the need for the palatal brace's stabilization as of claim 15, randomly placed throughout are vacuum ports disabling potential vacuum lock against the roof of the mouth.

17. A connecting lingual brace is connected to the lingual wall of the mandibular arch and such connection runs between bicuspids 21-20, and bicuspids 28-29.

18. As of claim 17, the palatal brace is conforming

19. A stabilization of the lingual brace exerted with the force of the tongue, and possibly aided by slight pressure by the fore finger and thumb on the cheeks cutaneous, enables the teeth in the maxillary arch to be cleaned as of claims 7 and 9 by merely chewing.

20. For additional comfort on the part of the user an inhalation port is provided through the forward portion of the appliance's body, enabling inhalation and exhalation, should nasal passages be obstructed

21. Significantly the oral appliance is potentially more easily disposed of in traditional; septic systems as it's characteristic of being water soluble.

22. Significantly the oral appliance is enhanced by its biodegradable characteristics affording an environmentally friendly disposal.
